(19) United States
(12) Patent Application Publication
(10) Pub. No.: US 2015/0313417 A1
(43) Pub. Date: Nov. 5, 2015

(54) SAFETY RESPONSE SYSTEM, METHOD, AND KIT

(71) Applicant: Richard E. Allred, Highland, UT (US)

(72) Inventor: Richard E. Allred, Highland, UT (US)

(21) Appl. No.: 14/267,728

(22) Filed: May 1, 2014

(51) Int. Cl. A47K 3/28; A47K 10/02; B65D 81/02; A61H 35/02

(52) U.S. Cl. CPC A47K 3/28; A61H 35/02; A47K 10/02; B65D 81/02

(57) ABSTRACT

The disclosure extends to safety response systems, methods and devices, and more particularly, but not necessarily entirely, to safety response systems, methods and kits for use in conjunction with a safety shower or safety eyewash unit, which may be used in various industries that require such safety showers or safety eyewash equipment.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND

The disclosure relates generally to safety response systems, methods and devices, and more particularly, but not necessarily entirely, to a safety response system, method and kit for use in conjunction with a safety shower or safety eyewash unit, which may be used in various industries that require such safety showers or safety eyewash equipment.

In many fields, it is a requirement to have emergency eyewashes and showers, where the eyes or body of any person may be exposed to injurious corrosive materials. In any industry in which such exposure is possible, it is a requirement to provide suitable facilities for quick drenching or flushing of the eyes and body. The emergency equipment must be located within the work area for immediate emergency use. According to at least one safety standard, an eyewash and/or safety shower would be required where an employee's eyes or body could be exposed to injurious corrosive materials. If none of the materials used in the work area is an injurious corrosive chemical or material (as indicated by the Material Safety Data Sheet (MSDS) for each product), then an emergency eyewash or shower would not be required.

The current standard addressing emergency eyewash and shower equipment provides for eyewash and shower equipment in appropriate situations when employees are exposed to hazardous materials. Hazardous materials include caustics, as well as additional substances and compounds that have the capability of producing adverse effects on the health and safety of humans. The safety standards also provide details with respect to the location, installation, nature, and maintenance of eyewash and shower equipment.

When the need arises for using the emergency safety showers or eyewash equipment, it is often due to exposure to hazardous materials that corrode and continue to burn through clothing worn by the affected person. Thus, it is often the case that a person using the equipment must enter the shower and remove the clothing that has been exposed to the hazardous material. Because these emergency showers are required to be located near the hazardous area, there is no thought to modesty or the work environment, such as a mixed work environment with both men and women working in the area. Thus, a person may be subjected or exposed to a mixed work environment while their clothing has been removed. Further, these safety showers and eyewash equipment are not equipped with any ability to assist the user in leaving the work premises in a modest manner.

What is needed is a safety shower system, method or kit that provides a modicum of modesty, whether in mixed environments (e.g., environments in which men and women are in the same workplace) or otherwise; that provides safety for a person who has need to use such a safety shower or safety eyewash because clothing with hazardous material or chemical burns will continue to burn a person while clothing is on, such that the removal and change of clothes is essential; that provides a system and method for not re-contaminating an environment or the person who has been exposed to hazardous materials; and/or allows a person to transport himself/herself without being naked without replacement clothing and protection. As will be seen, the disclosure provides such systems, methods and kits that can provide a modicum of modesty, whether in mixed environments or otherwise; that can provide safety for a person who has need to use such a safety shower or safety eyewash because clothing with chemical burns will continue to burn a person while clothing is on, such that the removal and change of clothes is essential; that can provide a system and method for not re-contaminating an environment or the person who has been exposed to hazardous materials; and/or allows a person to transport himself/herself without being naked without replacement clothing and protection in an effective and elegant manner.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. The features and advantages of the disclosure will become apparent from consideration of the description and accompanying drawings where:

FIG. 1 is a perspective view of an implementation of a safety shower made in accordance with the teachings and principles of the disclosure;

FIG. 2 is a perspective view of an implementation of a safety shower made in accordance with the teachings and principles of the disclosure;

FIG. 3 illustrates a kit made for use with a safety shower or eyewash safety bath in accordance with the teachings and principles of the disclosure;

FIG. 4 illustrates the contents of a kit made in accordance with the teachings and principles of the disclosure;

FIG. 5 illustrates the contents of a kit made in accordance with the teachings and principles of the disclosure;

FIG. 6 illustrates a kit and system made in accordance with the teachings and principles of the disclosure;

FIG. 7 illustrates the contents of a kit made in accordance with the teachings and principles of the disclosure.

### DETAILED DESCRIPTION

The disclosure extends to safety response systems, methods and devices, and more particularly, but not necessarily entirely, to a safety response system, method and kit for use in conjunction with a safety shower or safety eyewash bath or unit, which may be used in various industries that require such safety showers or safety eyewash equipment. In the following description of the disclosure, reference is made to the accompanying drawings, which form a part hereof, and in which is shown by way of illustration specific implementations in which the disclosure may be practiced. It is understood that other implementations may be utilized and structural changes may be made without departing from the scope of the disclosure.

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure.

It is to be understood that this disclosure is not limited to the particular configurations, process steps, and materials disclosed herein as such configurations, process steps, and materials may vary somewhat. It is also to be understood that the terminology employed herein is used for the purpose of describing particular embodiments only and is not intended to be limiting.

In describing the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element, step, or material not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

It will be appreciated that various safety regulations require that whenever a person gets contaminated by hazardous materials, whether in a fluidic state or a solid state, and the material cannot be readily removed, for example by washing the person's hands or the material is splashed into the employee's eyes, then eyewash baths or units and/or safety showers should be used. Such safety showers and eyewashes are used to keep the hazardous material or contaminant from entering the person's skin. Safety showers and eyewashes are the first line treatment of accidental contamination of the body and eyes of individuals working with hazardous materials.

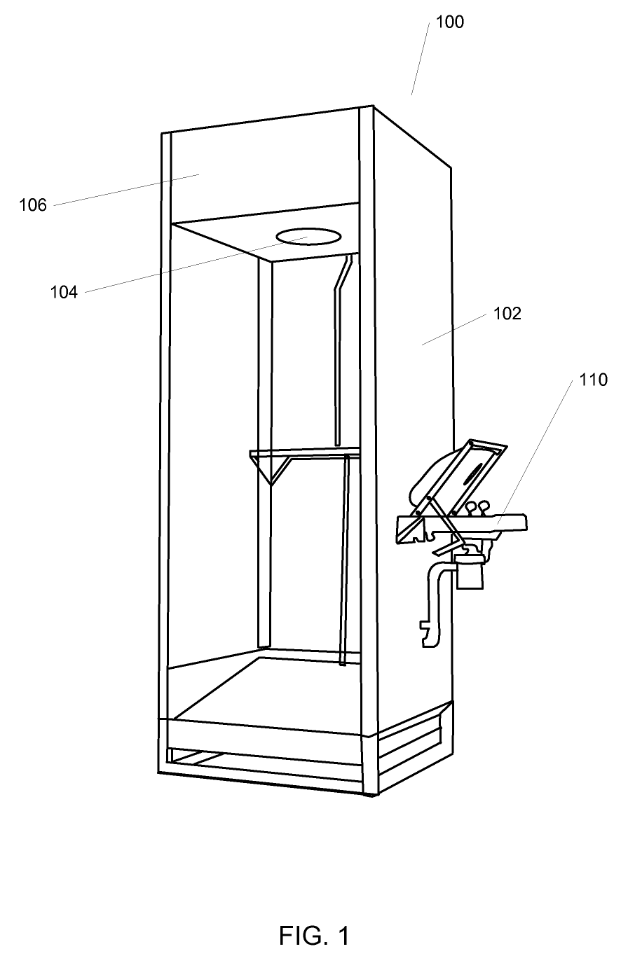

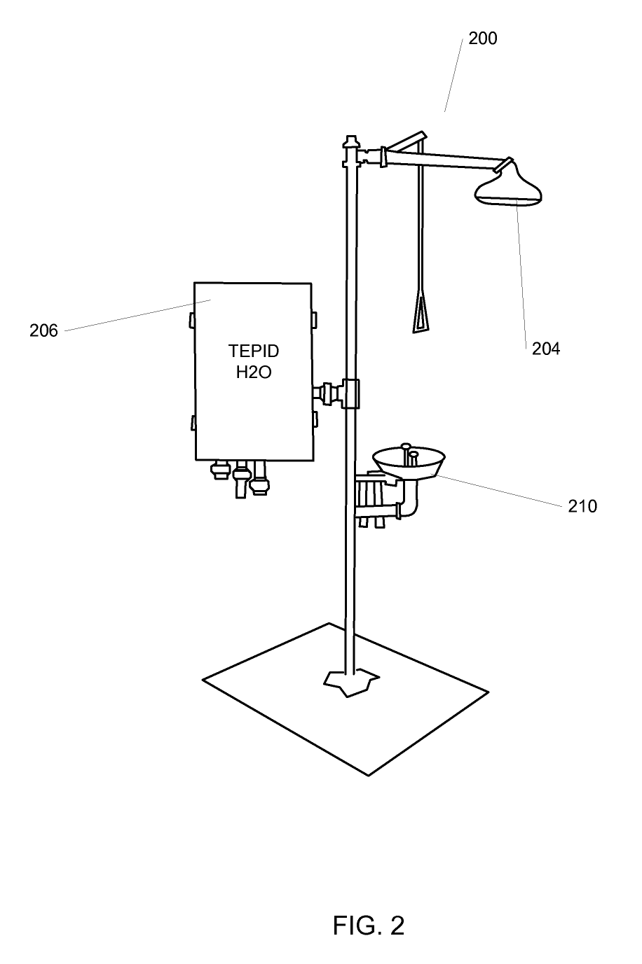

Referring now to the figures, it will be appreciated that the safety response kit of the disclosure may be used in conjunction with a safety shower or safety eyewash bath or unit. FIG. 1 illustrates an implementation of a safety shower 100. In this implementation, the safety shower 100 comprises a safety eyewash bath or unit 110 on an outer portion 102 of the safety shower 100. FIG. 2 illustrates an implementation of a safety shower 200, wherein the safety shower 200 may comprise a safety eyewash bath or unit 210 that may be implemented as part of the safety shower 200 itself or otherwise connected to the plumbing of the safety shower 200.

Generally, a safety shower 100, 200 may comprise an overhead water outlet 104, 204, such as a spray, and a water source 106, 206, which may be a substantially continuous water source or a limited water source, which sources may include a water tank, water container of a particular size, or any other water source container. The container should be suitable for providing tepid water for emergency use. It will be appreciated that other structural components, such as pipes, housings, flooring, shower enclosure or structure, curtains, doors, etc., may also be present in various implementations of a safety shower and such components are intended to fall within the scope of the disclosure. It will be appreciated that the kit and system of the disclosure may be used with any safety shower or eyewash bath or unit that is known or that may become known in the future, and such safety showers and eyewash units are contemplated by and fall within the scope of the disclosure.

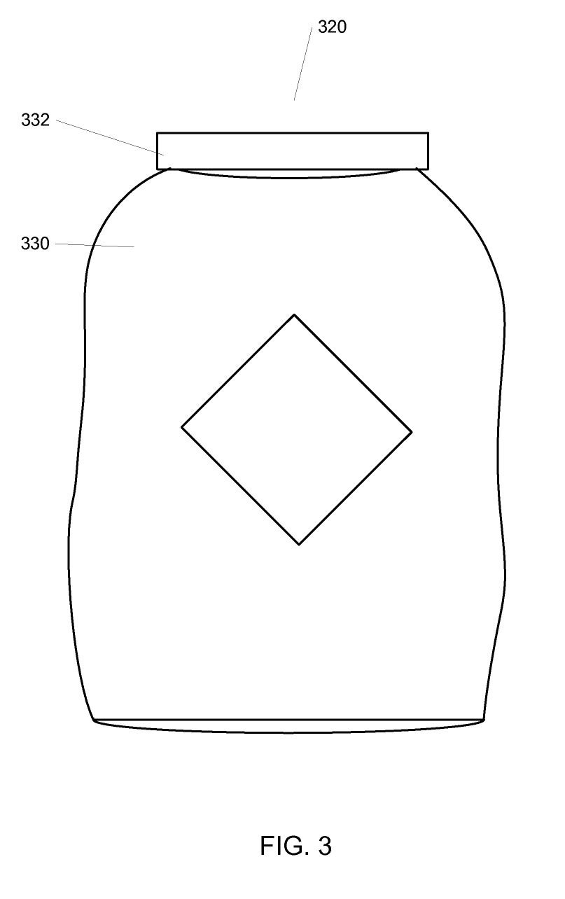

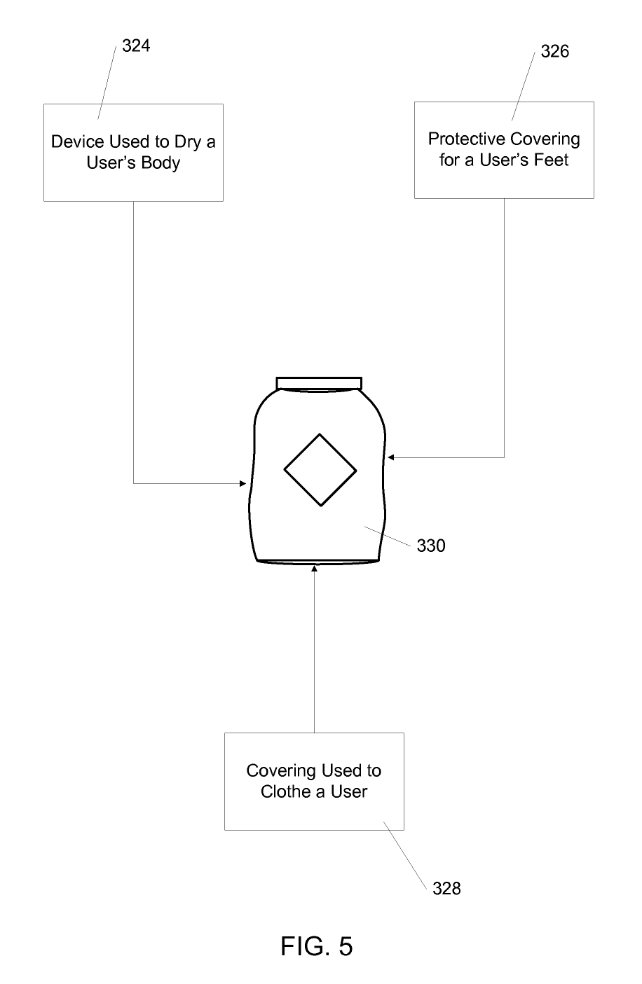

Referring now to FIGS. 3-6, there is illustrated a kit 320 made in accordance with the teachings and principles of the disclosure. As illustrated best in FIG. 3, the kit 320 of the disclosure may comprise a container 330 comprising a liquid tight seal 322, such that contents located or contained within the container 330 may be kept dry in environments where liquids are present, such as in a safety shower 100, 200. The container 330 may be made of suitable material to withstand liquid from entering the material. It will be appreciated that any such material may be used without departing from the scope of the disclosure. As noted more fully herein, the container 330 may be used to store or house various items or elements that may be used during an emergency situation to assist and aid a user in need of a safety shower or eyewash bath. Thus, it will be appreciated that it may be advantageous to use a material that is not only resistant to water or liquid penetration, but that may be flexible enough to be folded or otherwise moveable. The ability to move or fold the material may be helpful in sealing the opening or otherwise provide comfort and convenience benefits.

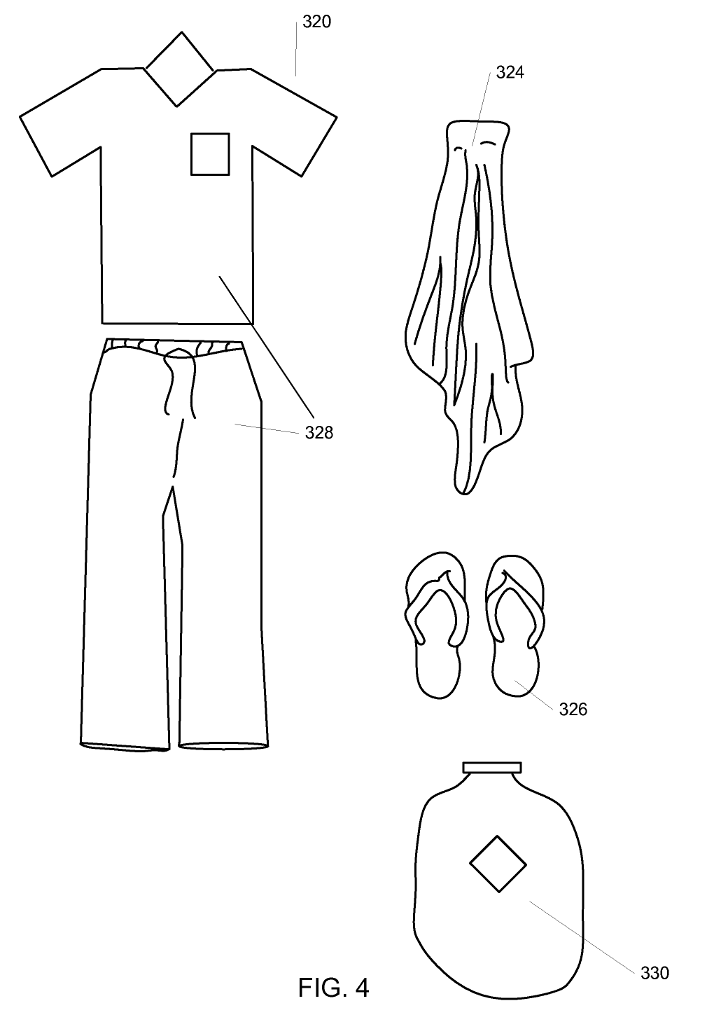

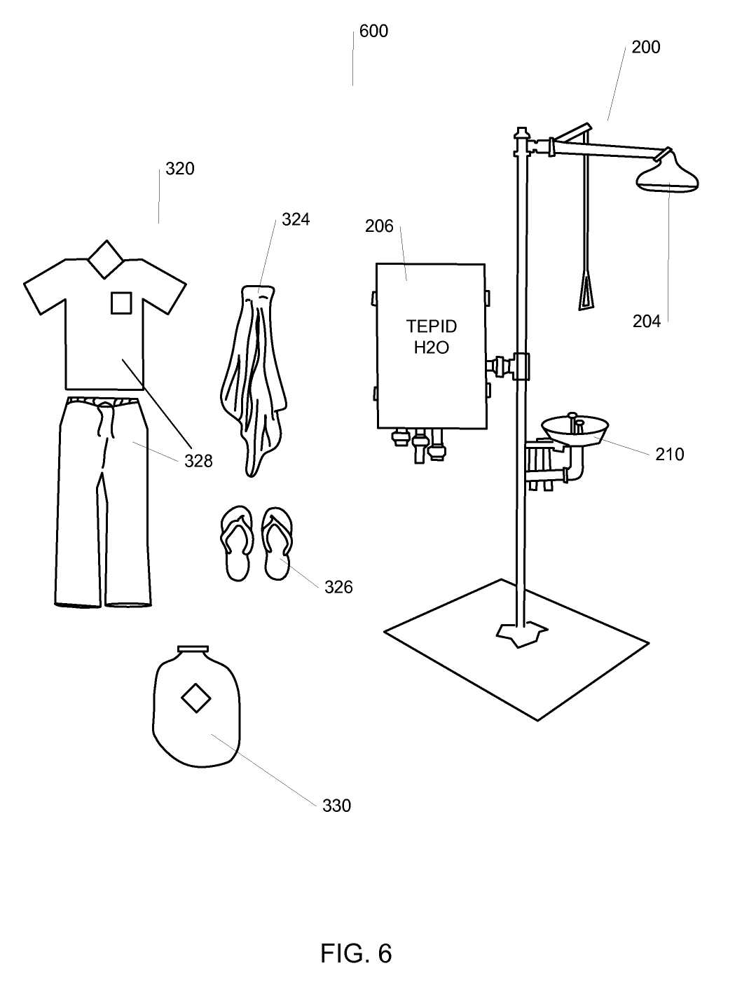

As illustrated best in FIGS. 4 and 6, the kit 320 may also comprise a device 324 that may be used to dry a user's body. Such a device 324 may include a towel, a shammy towel, a disposable wipe, a non-disposable wipe, a chemically inert towel, a chemically neutralizing towel, or another type of drying device capable of drying at least a portion of person's body without departing from the scope of the disclosure.

The kit 320 may include a protective covering 326 for a user's feet. It will be appreciated that the protective covering 326 for a user's feet may be a pair of sandals, a pair of shoes, a pair of shoe covers, a pair of disposable covers, a pair of non-disposable covers, or another type of protective covering for protecting a user's feet. It will be appreciated that such covering may be made from any suitable materials for protecting or covering a user's feet without departing from the scope of the disclosure.

The kit 320 may include a covering 328 used to clothe a user, such that the user is provided with increased modesty capability. It will be appreciated that the covering used to clothe a user may comprise a scrub top and a scrub pants. It will be appreciated that the covering used to clothe a user may be any other suitable form other than a scrub top or scrub bottom, such as any type of pants, shirt, shield or any other type of covering or material made in any form. The material used to cover or clothe a user may comprise a disposable material, a non-disposable material, or another type of material used to clothe or cover a user. It will be appreciated that the other types of materials may be used without departing from the scope of the disclosure.

In an implementation, a safety response kit 320 for use with a safety shower 100, 200 or safety eyewash bath 110, 210 may consist of: a container comprising a liquid tight seal, such that contents within the container are kept dry in environments where liquids are present; a device used to dry a user's body; a protective covering for a user's feet; and a covering used to clothe a user, such that the user is provided with increased modesty capability. It will be appreciated that the safety response kit may be a separate element or may be a part of the safety shower, without departing from the scope of the disclosure.

Referring now to FIG. 6, there is illustrated a safety response system 600, which may comprise a safety shower 100 or 200. It will be appreciated that the safety shower may be any safety shower and may generally comprise a water supply container 106, 206 and an overhead spray 104, 204.

The safety response system 600 may comprise a safety response kit 320 for use with the safety shower 100, 200. The kit 320 may comprise a container 330 as noted above that may comprise a liquid tight seal, such that contents within the container 330 may kept dry in environments where liquids are present. The kit 320 may further comprise a device 324 used to dry a user's body, a protective covering 326 for a user's feet, and a covering 328 used to clothe a user, such that the user is provided with increased modesty capability. It will be appreciated that the contents of the kit may be located within the container 330 and sealed to keep the contents of the kit substantially free from moisture or exposure to liquids from the safety shower 100, 200 or eyewash bath 110, 210. However, it will be appreciated that the contents of the safety response system or kit 320 do not necessarily have to be stored in a water tight sealed container 330. The contents of the system or kit may be stored in any container made of any suitable material. The container may be located outside of the safety shower or out of the eyewash bath area, but still within a reasonable distance whereby users may readily retrieve the contents of the kit. Thus, the container of the disclosure is not required to be located within the safety shower. It may be advantageous to house the container and its contents in or near the safety shower or eyewash bath for easy use by a user of the safety shower or eyewash bath.

It will be appreciated that the safety response system may comprise an eyewash safety bath 110, 210. The device 324 used to dry a user's body of the safety response system may comprise a towel, a shammy towel, a disposable wipe, a non-disposable wipe, a chemically inert towel, a chemically neutralizing towel, or another type of drying device capable of drying at least a portion of person's body without departing from the scope of the disclosure. The protective covering 326 may be a pair of sandals, a pair of shoes, a pair of shoe covers, a pair of disposable covers, a pair of non-disposable covers, or another type of protective covering for protecting a user's feet. It will be appreciated that such covering may be made from any suitable materials for protecting or covering a user's feet without departing from the scope of the disclosure. The covering 328 used to clothe a user, such that the user is provided with increased modesty capability, may comprise a scrub top and a scrub pants. It will be appreciated that the covering used to clothe a user may be any other suitable form other than a scrub top or scrub bottom, such as any type of pants, shirt, shield or any other type of covering or material made in any form. The material used to cover or clothe a user may comprise a disposable material, a non-disposable material, or another type of material used to clothe or cover a user. It will be appreciated that the other types of materials may be used without departing from the scope of the disclosure.

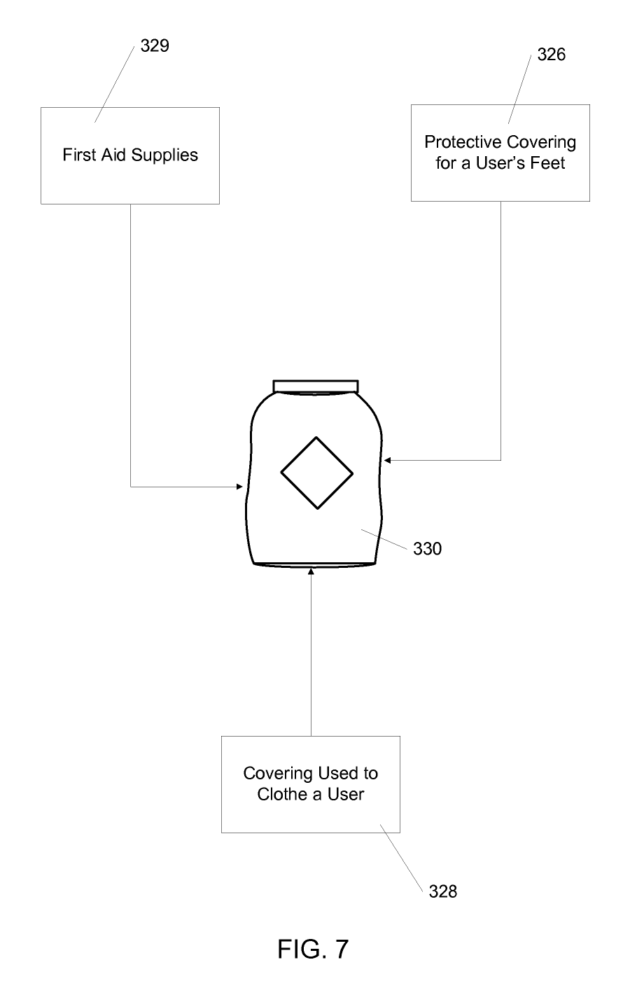

Referring now to FIG. 7, the kit 320 may comprise a container 330 as noted above. The kit 320 may further comprise a protective covering for protecting a user's feet, a covering 328 used to clothe a user, such that the user is provided with increased modesty capability, and first aid supplies 329. The first aid supplies 329 may be supplied as part of the system or as part of the kit 320 itself. It will be appreciated that the first aid supplies 329 may be located within the container 330 or the first aid supplies 329 may simply be stored in the vicinity of the safety shower or eyebath wash without departing from the scope of the disclosure. It will be appreciated that the contents of the kit may be located within the container 330 and sealed to keep the contents of the kit substantially free from moisture or exposure to liquids from the safety shower 100, 200 or eyewash bath 110, 210. However, it will be appreciated that the contents of the safety response system or kit 320 do not necessarily have to be stored in a water tight sealed container 330. For example, the contents of the system or kit may be stored in any container and may be located outside of the safety shower or out of the eyewash bath area, but still within a reasonable distance whereby users may readily retrieve the contents of the kit.

In an implementation, the safety response system or kit 320 may be attached or otherwise connected to an existing safety shower/safety eyewash or newly installed safety shower/eyewash. In an implementation, the safety response system or kit 320 may be stored near or in the vicinity of the safety shower/safety eyewash with other first response or first aid supplies 329.

It will be appreciated that the kit of the disclosure and the safety components contained therein may be intended for one-time or single use due to chemical exposure or if first responders have need for decontamination in order to transport a person to a facility.

Those having ordinary skill in the relevant art will appreciate the advantages provided by the features of the disclosure. For example, it is a potential feature of the disclosure to provide a kit for use with a safety shower or safety eyewash bath or unit. Another potential feature of the disclosure is a safety shower system, method or kit that provides a modicum of modesty, whether in mixed environments (e.g., environments in which men and women are in the same workplace) or otherwise. It is a potential feature of the disclosure to provide a safety shower system, method or kit that provides safety for a person who has need to use such a safety shower or safety eyewash bath because clothing with hazardous material or chemical burns will continue to burn a person while clothing is on, such that the removal and change of clothes is required. It is another potential feature of the disclosure to provide a safety shower system, method or kit that provides the ability for not re-contaminating an environment or the person who has been exposed to hazardous materials. It is a potential feature of the disclosure to provide a safety shower system, method or kit that allows a person to transport himself/herself without being naked without a set or change of replacement clothing and protection. It is a potential feature of the disclosure to provide a safety shower system, method or kit that is simple in use and operation and allows a user various benefits in an effective and elegant manner.

In the foregoing Detailed Description, various features of the disclosure are grouped together in a single embodiment for the purpose of streamlining the disclosure. This method of disclosure is not to be interpreted as reflecting an intention that the claimed disclosure requires more features than are expressly recited herein.

It is to be understood that the above-described arrangements are only illustrative of the application of the principles of the disclosure. Numerous modifications and alternative arrangements may be devised by those skilled in the art without departing from the spirit and scope of the disclosure and are intended to cover such modifications and arrangements. Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A safety response kit for use with a safety shower or safety eyewash, the kit comprising:
a container comprising a liquid tight seal, such that contents within the container are kept dry in environments where liquids are present;
a protective covering for a user's feet; and
a covering used to clothe a user, such that the user is provided with increased modesty capability.

2. The safety response kit of claim 1, wherein the kit further comprises a device used to dry a user's body.

3. The safety response kit of claim 2, wherein the device used to dry a user's body is a towel.

4. The safety response kit of claim 2, wherein the device used to dry a user's body is a disposable wipe.

5. The safety response kit of claim 2, wherein the device used to dry a user's body is a non-disposable wipe.

6. The safety response kit of claim 2, wherein the device used to dry a user's body is a chemically inert towel.

7. The safety response kit of claim 2, wherein the device used to dry a user's body is a chemically neutralizing towel.

8. The safety response kit of claim 1, wherein the protective covering for a user's feet is a pair of sandals.

9. The safety response kit of claim 1, wherein the protective covering for a user's feet is a pair of shoes.

10. The safety response kit of claim 1, wherein the protective covering for a user's feet is a pair of shoe covers.

11. The safety response kit of claim 1, wherein the protective covering for a user's feet is a pair of disposable covers.

12. The safety response kit of claim 1, wherein the protective covering for a user's feet is a pair of non-disposable covers.

13. The safety response kit of claim 1, wherein the covering used to clothe a user comprises a scrub top and scrub pants.

14. The safety response kit of claim 1, wherein the covering used to clothe a user comprises a disposable material.

15. The safety response kit of claim 1, wherein the covering used to clothe a user comprises a non-disposable material.

16. The safety response kit of claim 1, wherein the kit further comprises first aid supplies.

17. A safety response kit for use with a safety shower or safety eyewash, the kit consisting of:
a container comprising a liquid tight seal, such that contents within the container are kept dry in environments where liquids are present;
a device used to dry a user's body;
a protective covering for a user's feet; and
a covering used to clothe a user, such that the user is provided with increased modesty capability.

18. A safety response system comprising:
a safety shower comprising:
a water supply container; and
an overhead spray;
a safety response kit for use with the safety shower, the kit comprising:
a container comprising a liquid tight seal, such that contents within the container are kept dry in environments where liquids are present;
a protective covering for a user's feet; and
a covering used to clothe a user, such that the user is provided with increased modesty capability.

19. The safety response system of claim 18, wherein the safety shower further comprises an eyewash safety bath.

20. The safety response system of claim 18, wherein the system further comprises a device used to dry a user's body.

21. The safety response system of claim 20, wherein the device used to dry a user's body is a towel.

22. The safety response system of claim 20, wherein the device used to dry a user's body is a disposable wipe.

23. The safety response system of claim 20, wherein the device used to dry a user's body is a non-disposable wipe.

24. The safety response system of claim 20, wherein the device used to dry a user's body is a chemically inert towel.

25. The safety response system of claim 20, wherein the device used to dry a user's body is a chemically neutralizing towel.

26. The safety response system of claim 18, wherein the protective covering for a user's feet is a pair of sandals.

27. The safety response system of claim 18, wherein the protective covering for a user's feet is a pair of shoes.

28. The safety response system of claim 18, wherein the protective covering for a user's feet is a pair of shoe covers.

29. The safety response system of claim 18, wherein the protective covering for a user's feet is a pair of disposable covers.

30. The safety response system of claim 18, wherein the protective covering for a user's feet is a pair of non-disposable covers.

31. The safety response system of claim 18, wherein the covering used to clothe a user comprises a scrub top and scrub pants.

32. The safety response system of claim 18, wherein the covering used to clothe a user comprises a disposable material.

33. The safety response system of claim 18, wherein the covering used to clothe a user comprises a non-disposable material.

34. The safety response system of claim 18, wherein the system further comprises first aid supplies that are part of the safety response kit.
